(19) United States
(12) Patent Application Publication
(10) Pub. No.: US 2024/0369211 A1
(43) Pub. Date: Nov. 7, 2024

(54) LIGHT EMITTING DEVICE HAVING IMPROVED ILLUMINATION AND MANUFACTURING FLEXIBILITY

(71) Applicant: FEIT ELECTRIC COMPANY, INC., Pico Rivera, CA (US)

(72) Inventors: Alan Feit, Los Angeles, CA (US); Gerardo Cisneros, Buena Park, CA (US)

(21) Appl. No.: 18/772,751

(22) Filed: Jul. 15, 2024

Related U.S. Application Data
(63) Continuation of application No. 18/470,914, filed on Sep. 20, 2023, now Pat. No. 12,066,173.
Application No. 18/470,914 is a continuation of application No. 17/988,623, filed on Nov. 16, 2022, now Pat. No. 11,796,163.
Application No. 17/988,623 is a continuation of application No. 15/930,306, filed on May 12, 2020, now Pat. No. 11,592,166.

(51) Int. Cl. F21V 23/00; F21V 23/06; F21V 29/70; F21Y 115/10

(52) U.S. Cl. CPC F21V 23/005; F21V 23/001; F21V 23/06; F21V 29/70; F21Y 2115/10

(57) ABSTRACT

Systems, methods, and apparatuses provide a light emitting device including one or more arrays of light emitting diodes attached to a first outward facing surface of a first substrate. The light emitting device further includes driver circuitry attached to a second outward facing surface of a second substrate. The light emitting device further includes a wire connection electrically coupling the first substrate and the second substrate such that the driver circuitry drives the one or more arrays of light emitting diodes. The light emitting device further includes an enclosure for housing the first substrate, the second substrate, and the wire connection.

### CROSS-REFERENCE TO RELATED APPLICATION

The present application is a continuation of U.S. patent application Ser. No. 18/470,914, filed Sep. 20, 2023; which is a continuation of U.S. patent application Ser. No. 17/988,623, filed Nov. 16, 2022, and now U.S. Pat. No. 11,796,163; which is a continuation of U.S. Nonprovisional application Ser. No. 15/930,306, filed May 12, 2020, and now U.S. Pat. No. 11,592,166; the entire contents of all of which as are hereby incorporated by reference herein.

### BACKGROUND

Light emitting devices may comprise light emitting diodes. Light emitting diodes (also referred to herein as LEDs) are semiconductor devices that emit light when an electric current is passed through them. The light is produced when particles that carry the electric current (i.e., electrons and holes) combine together with the semiconductor material of the semiconductor devices. LEDs are described as solid-state devices, which distinguishes them from other lighting technologies that use heated filaments or gas discharge as lighting sources (e.g., incandescent, tungsten halogen lamps; fluorescent lamps). For lighting applications, LED die are typically incorporated in packages that provide reflector structure, electrical connections, thermal connections, and light conversion phosphor.

LEDs are widely used in lighting applications for residential and commercial structures. Light bulbs utilizing LEDs are far more efficient when compared to traditional lighting such as incandescent and fluorescent lights. Most of the energy in LEDs is converted into light and a minimal amount results in heat.

Through applied effort, ingenuity, and innovation many deficiencies of such systems have been solved by developing solutions that are in accordance with the embodiments of the present invention, many examples of which are described in detail herein.

### SUMMARY

Embodiments of the present disclosure provide a light emitting device including one or more arrays of light emitting diodes attached to a first outward facing surface of a first substrate. The light emitting device further includes driver circuitry attached to a second outward facing surface of a second substrate. The light emitting device further includes a wire connection electrically coupling the first substrate and the second substrate such that the driver circuitry drives the one or more arrays of light emitting diodes. The light emitting device further includes an enclosure for housing the first substrate, the second substrate, and the wire connection.

In embodiments, one or more of the first substrate or the second substrate comprises sapphire. In embodiments, the light emitting device further includes an outer layer of phosphor outside the first outward facing surface of the first substrate and the second outward facing surface of the second substrate.

In embodiments, the light emitting device further includes a ceramic base.

In embodiments, the light emitting device further includes one or more of an Edison base, an E11 base, a G4 base, a G8 base, a G9 base, a Wedge base, a Bayonet base, or a DC Bayonet base.

In embodiments, the light emitting device is configured for emitting light in one or more of a wall fixture, a step light, a mini pendant light, a decorative sconce light, a desk lamp, or an outdoor fixture.

In embodiments, the enclosure is one or more of clear, opaque, shatterproof, glass, or plastic.

In embodiments, the enclosure is filled with gas for cooling the LED arrays. In embodiments, the first substrate and the second substrate are surrounded by a phosphor layer.

In embodiments, the light emitting device further includes a plurality of LED arrays attached to the first outward facing surface of the first substrate.

This Summary does not attempt to completely signify any particular innovation, embodiment, or example as it can be used in commerce. Additionally, this Summary is not intended to signify essential elements of an innovation, embodiment or example or to limit the scope of the subject matter of this disclosure.

The innovations, embodiments, and/or examples found within this disclosure are not all-inclusive, but rather describe the basic significance of the subject matter. Accordingly, one use of this Summary is as a prelude to a Detailed Description presented later.

### BRIEF DESCRIPTION OF THE DRAWINGS

The following Detailed Description, Figures, and appended Claims signify the nature and advantages of the innovations, embodiments and/or examples of the claimed inventions. All of the Figures signify innovations, embodiments, and/or examples of the claimed inventions for purposes of illustration only and do not limit the scope of the claimed inventions. Such Figures are not necessarily drawn to scale, and are part of the Disclosure.

In the Figures, similar components or features may have the same, or similar, reference signs in the form of labels (such as alphanumeric symbols, e.g., reference numerals), and may signify similar or equivalent functionality. Further, various components of the same type may be distinguished by following the reference label by a dash and a second label that distinguishes among the similar components. If only the first reference label is used in the specification, the description is applicable to any one of the similar components having the same first reference label irrespective of the second reference label. A brief description of the Figures is below.

FIG. 1A illustrates an exemplary conventional light emitting device;

FIG. 1B illustrates an exemplary conventional light emitting device;

FIG. 2A illustrates an exemplary light emitting device configured in accordance with embodiments of the present disclosure;

FIG. 2B illustrates an exemplary light emitting device configured in accordance with embodiments of the present disclosure;

FIG. 2C illustrates an exemplary light emitting device configured in accordance with embodiments of the present disclosure;

FIG. 3A illustrates an exemplary light emitting device configured in accordance with embodiments of the present disclosure;

FIG. 3B illustrates an exemplary light emitting device configured in accordance with embodiments of the present disclosure;

FIG. 3C illustrates an exemplary light emitting device configured in accordance with embodiments of the present disclosure;

FIG. 4A illustrates an exemplary light emitting device configured in accordance with embodiments of the present disclosure;

FIG. 4B illustrates an exemplary light emitting device configured in accordance with embodiments of the present disclosure;

FIG. 4C illustrates an exemplary light emitting device configured in accordance with embodiments of the present disclosure;

FIG. 5A illustrates an exemplary schematic of an exemplary light emitting device for use with embodiments of the present disclosure;

FIG. 5B illustrates an exploded view of an exemplary light emitting device for use with embodiments of the present disclosure;

FIGS. 6A and 6B illustrate an exemplary PCB layout for an exemplary light emitting device according to embodiments, as well as an exemplary schematic for an exemplary light emitting device according to embodiments;

FIGS. 7A and 7B illustrate an exemplary PCB layout for an exemplary light emitting device according to embodiments, as well as an exemplary schematic for an exemplary light emitting device according to embodiments;

FIG. 8 illustrates an exemplary light emitting device for use with embodiments of the present disclosure; and

FIG. 9 illustrates an exemplary light emitting device for use with embodiments of the present disclosure.

In such various figures, reference signs may be omitted as is consistent with accepted engineering practice; however, one of ordinary skill in the art will understand that the illustrated components are readily understood when viewed in context of the illustration as a whole and the accompanying disclosure describing such various figures.

### DETAILED DESCRIPTION

The Figures and the following Detailed Description signify innovations, embodiments and/or examples by way of illustration only, with various features, structures or characteristics described together in a single embodiment to streamline the disclosure. Variations of any of the elements, processes, machines, systems, manufactures or compositions disclosed by such exemplary innovations, embodiments and/or examples will be readily recognized and may be used in commerce without departing from the principles of what is claimed. The Figures and Detailed Description may also signify, implicitly or explicitly, advantages and improvements of a subset of the exemplary embodiments described herein.

In the Figures and Detailed Description, numerous specific details may be described to enable one or more of the exemplary innovations, embodiments and/or examples. In the interest of not obscuring the presentation of the exemplary innovations, embodiments and/or examples in the following Detailed Description, some processing steps or operations that are known in the art may be combined together for presentation and for illustration purposes and might not be described in detail. However, a person skilled in the art will recognize that these exemplary innovations, embodiments and/or examples may be used in commerce without these specific details or with equivalents thereof. In other instances, well-known processes and devices are not described in detail as not to unnecessarily obscure aspects of these exemplary innovations, embodiments and/or examples. In other instances, some processing steps or operations that are known in the art may not be described at all. Instead, the following description is focused on the distinctive features or elements of various exemplary innovations, embodiments and/or examples. Furthermore, while this description may refer to some components of the structure in the singular tense, more than one component may be depicted throughout the Figures and like components are labeled with like numerals.

Conventional small halogen light bulbs are being replaced by what are referred to as G9 LED bulbs due to the significant energy savings afforded by the LED bulbs. The term G9 refers to the base of the bulb, whereby the bulb is connected to a socket or light fixture. G9 LED bulbs (and the small halogen light bulbs they replace) comprise what is called two bi-pin connections for connecting to a light fixture. Other LED replacements for small halogen or incandescent light bulbs include those having a variety of base types (e.g., Edison (e.g., E10, E11, E26), G4, G6.35, GY6.35, and the like).

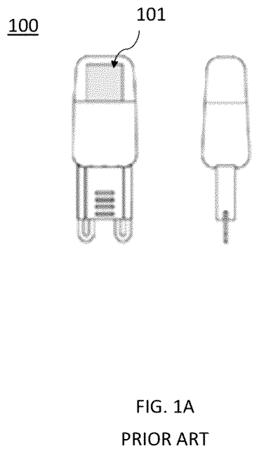

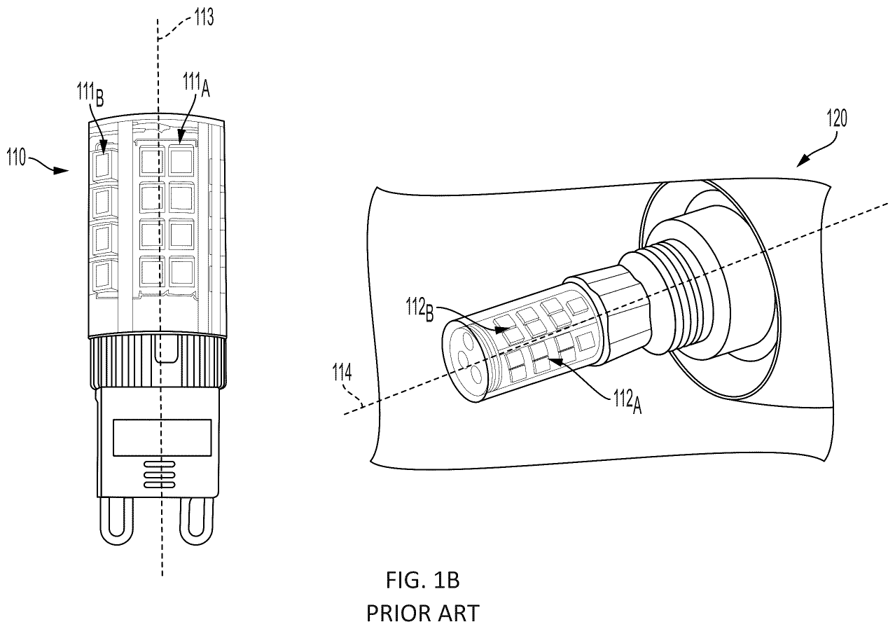

As shown in FIG. 1A, conventional designs for G9 and other LED bulbs typically comprise components including a single circuit board (or substrate) having an array of LEDs on a single surface of the single circuit board (or substrate) as well as control circuitry (not shown) on the same single circuit board or substrate. That is, a light bulb 100 includes a single circuit board 101 having an array of LEDs on a single surface of the circuit board 101. The light bulb 100 further includes control circuitry for the array of LEDs on the single surface of the circuit board 101 as well. In such conventional designs, the light emitted from the single surface does not spread out in a desired manner for most lighting applications.

Shown in FIG. 1B, in other conventional designs (e.g., 110, 120), the components include multiple single circuit boards (e.g., 111A, 111B, 112A, 112B) arranged in a hexagonal arrangement or other arrangement whereby the singular circuit boards are placed alongside one another and positioned around an axis (e.g., 113, 114). These singular circuit boards also include driver circuitry (not shown) for the individual LED arrays contained thereon as well. Manufacturing of such conventional designs is costly and complex considering the required arrangement of the driver circuitry in order to support each of the individual LED arrays and circuit boards in the appropriate locations.

Embodiments of the present disclosure overcome the aforementioned and other problems by providing a light emitting device (e.g., LED light bulb) comprising a first substrate or circuit board comprising one or more arrays of LEDs arranged on an outward facing surface of the substrate or circuit board, and a second substrate where the driver circuitry for the one or more arrays of LEDs is situated. In this manner, uniformly emitted light is provided, and manufacturing complexity is reduced. In embodiments, one or more of the first substrate or the second substrate comprises sapphire or ceramic material.

In embodiments, the first substrate and the second substrate may be connected via a singular wire connection such that the driver circuitry drives the one or more arrays of LEDs.

In embodiments, the light emitting device comprises a layer of phosphor surrounding the outward facing surfaces of each of the first substrate and the second substrate.

Embodiments of the present disclosure may include one or more of an Edison base, an E11 base, a G4 base, a G8 base, a G9 base, a Wedge base, a Bayonet base, or a DC Bayonet base. It will be appreciated that other base types may be used in conjunction with embodiments described herein without departing from the scope of the disclosure.

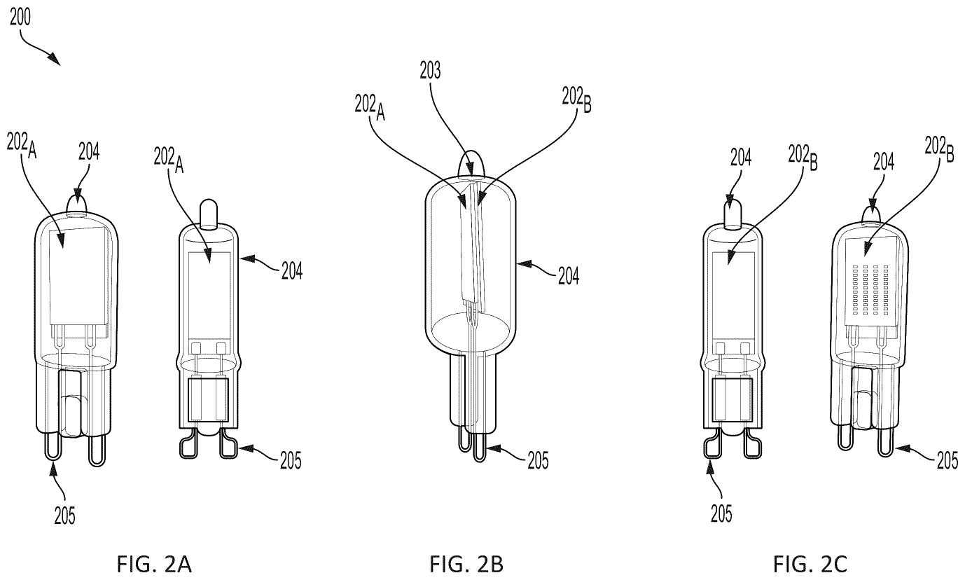

FIGS. 2A-2C illustrate an exemplary light emitting device 200 configured in accordance with embodiments of the present disclosure. In embodiments, an exemplary light emitting device 200 comprises a first LED array 202A on a first surface of a first substrate. The exemplary light emitting device 200 further comprises driver circuitry 202B on a second surface of a second substrate. The first surface of the first substrate and the second surface of the second substrate may be positioned opposite one another such that the first surface is facing outward in a first direction and the second surface is facing outward in a second direction that is 180 degrees from the first direction (i.e., the first surface is forward facing and the second surface is rear facing). The first surface and the second surface may be separated by an additional substrate layer 203. The additional substrate layer 203 may comprise sapphire or ceramic material.

The first LED array 202A, the driver circuitry 202B, and the optional additional substrate layer 203 are housed in an enclosure 204 (e.g., a glass, plastic, clear, opaque, transparent and/or shatterproof bulb). In embodiments, the enclosure 204 is filled with a gas that serves as a cooling system for the first LED array 202A. It will be appreciated that first LED array 202A may comprise a plurality of LED arrays. In embodiments, the first substrate and the second substrate may be connected via a singular wire connection such that the driver circuitry drives the one or more arrays of LEDs.

In embodiments, the first LED array 202A and the driver circuitry 202B are surrounded by a phosphor layer (not shown). The light emitting device 200 comprises connections 205 for insertion into a lighting socket or fixture (e.g., G9 base application).

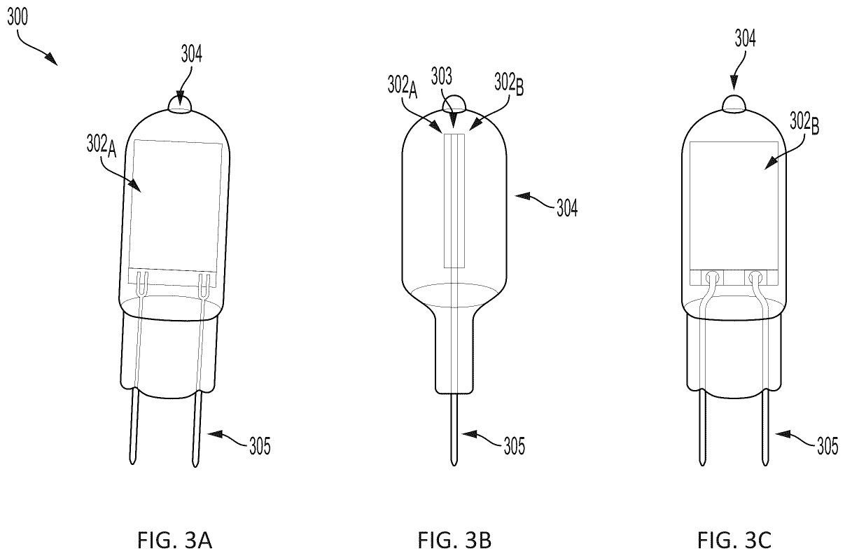

FIGS. 3A-3C illustrate an exemplary light emitting device 300 configured in accordance with embodiments of the present disclosure. In embodiments, an exemplary light emitting device 300 comprises a first LED array 302A on a first surface of a first substrate. The exemplary light emitting device 300 further comprises driver circuitry 302B on a second surface of a second substrate. In embodiments, the first substrate and the second substrate may be connected via a singular wire connection such that the driver circuitry drives the one or more arrays of LEDs.

The first surface of the first substrate and the second surface of the second substrate may be positioned opposite one another such that the first surface is facing outward in a first direction and the second surface is facing outward in a second direction that is 180 degrees from the first direction (i.e., the first surface is forward facing and the second surface is rear facing). The first surface and the second surface may be separated by an additional substrate layer 303. The additional substrate layer 303 may comprise sapphire or ceramic material.

The first LED array 302A, the driver circuitry 302B, and the optional additional substrate layer 303 are housed in an enclosure 304. The enclosure may be glass, plastic, shatterproof, transparent, clear, opaque, or the like. In embodiments, the enclosure 304 is filled with a gas that serves as a cooling system for the first LED array 302A. It will be appreciated that first LED array 302A may comprise a plurality of LED arrays.

In embodiments, the first LED array 302A and the driver circuitry 302B are surrounded by a phosphor layer (not shown). The light emitting device 300 comprises connections 305 for insertion into a lighting socket or fixture (e.g., GY6.35 base application).

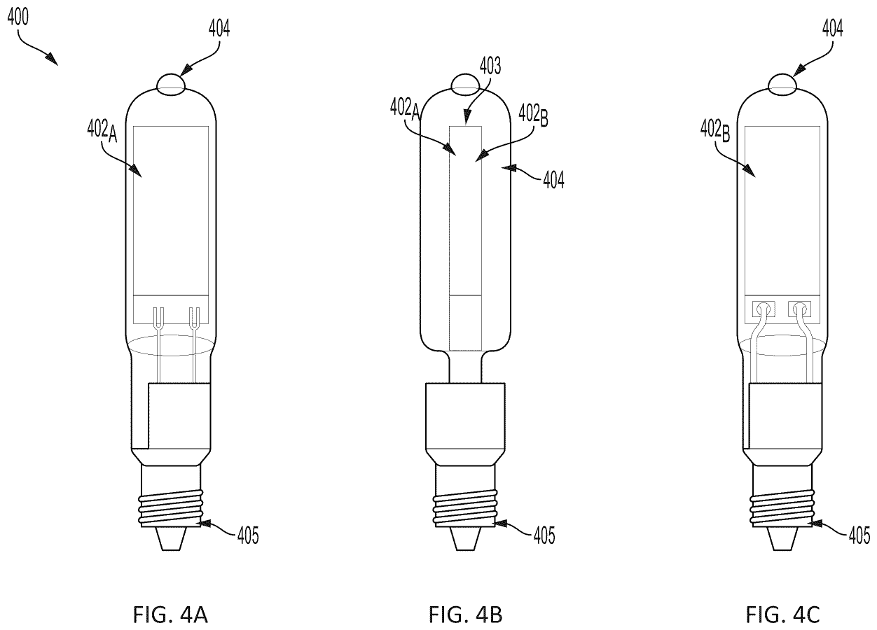

FIGS. 4A-4C illustrate an exemplary light emitting device 400 configured in accordance with embodiments of the present disclosure. In embodiments, an exemplary light emitting device 200 comprises a first LED array 402A on a first surface of a first substrate. The exemplary light emitting device 400 further comprises driver circuitry 402B on a second surface of a second substrate. In embodiments, the first substrate and the second substrate may be connected via a singular wire connection such that the driver circuitry drives the one or more arrays of LEDs.

The first surface of the first substrate and the second surface of the second substrate may be positioned opposite one another such that the first surface is facing outward in a first direction and the second surface is facing outward in a second direction that is 180 degrees from the first direction (i.e., the first surface is forward facing and the second surface is rear facing). The first surface and the second surface may be separated by an additional substrate layer 403. The additional substrate layer 403 may comprise sapphire or ceramic material.

The first LED array 402A, the driver circuitry 402B, and the optional additional substrate layer 203 are housed in an enclosure 404. The enclosure may be glass, plastic, shatterproof, transparent, clear, opaque, or the like. In embodiments, the enclosure 404 is filled with a gas that serves as a cooling system for the first LED array 402A. It will be appreciated that first LED array 402A may comprise a plurality of LED arrays.

In embodiments, the first LED array 402A and the driver circuitry 402B are surrounded by a phosphor layer (not shown). The light emitting device 400 comprises connections 405 for insertion into a lighting socket or fixture (e.g., E11 base/mini candelabra application).

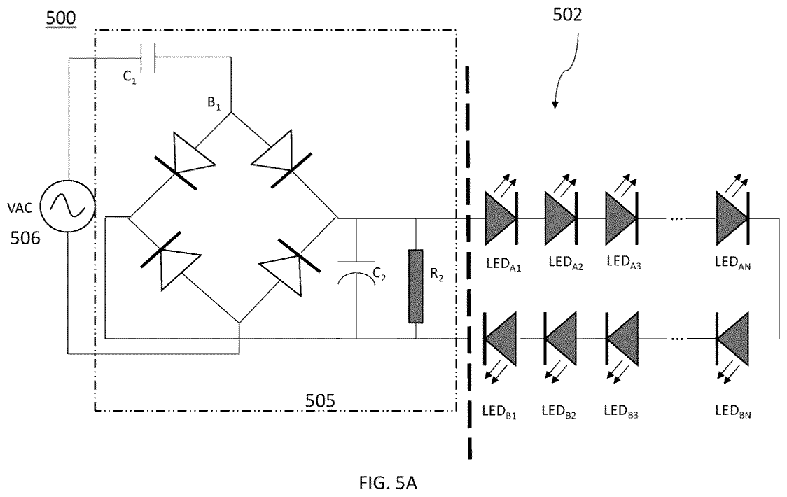

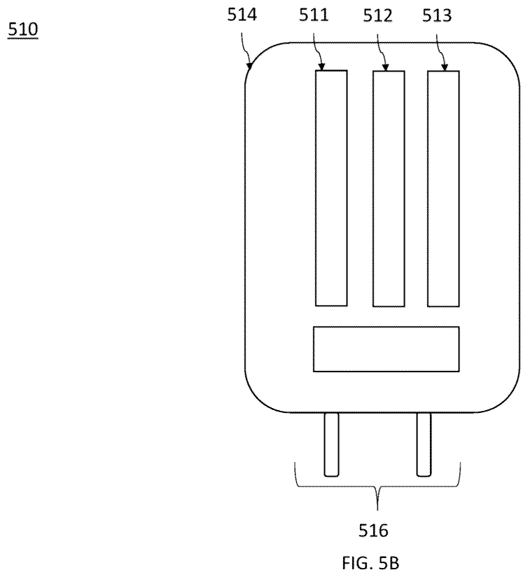

FIG. 5A illustrates an exemplary schematic of an exemplary light emitting device 500, for use with embodiments of the present disclosure. FIG. 5B illustrates an exploded view of the exemplary light emitting device 500 for use with embodiments of the present disclosure. In embodiments, the exemplary light emitting device 500 comprises a first LED array 511 (e.g., 502 of FIG. 5A) on a first surface of a first substrate, and control circuitry 513 (e.g., 505 of FIG. 5A). In embodiments, the first LED array 511 (e.g., 502 of FIG. 5A) comprises a first plurality of LEDs (e.g., LED_{A1}, LED_{A2}, LED_{A3}, LED_{B1}, LED_{B2}, LED_{B3}, etc.) connected in series. An electrical coupling (not shown) connects the first plurality of LEDs with the control circuitry. The first LED array 511 may comprise a plurality of LED arrays, in embodiments. In embodiments, the first substrate and the second substrate may be connected via a singular wire connection such that the driver circuitry drives the one or more arrays of LEDs.

The first surface of the first substrate and the second surface of the second substrate are positioned opposite one another such that the first surface is facing outward in a first direction and the second surface is facing outward in a second direction that is 180 degrees from the first direction (i.e., the first surface is forward facing and the second surface is rear facing). The first substrate and the second substrate are separated by an optional additional substrate layer 512. The first LED array 511, the optional additional substrate layer 512, the control circuitry 513 (e.g., circuitry 505 of FIG. 5A) supporting them are housed in an enclosure 514. The enclosure may be glass, plastic, shatterproof, transparent, clear, opaque, or the like. The light emitting device 510 comprises connections 516 for insertion into a lighting socket or fixture (e.g., to electrically couple with a voltage source such as VAC 506 of FIG. 5A). The enclosure 514 may be filled with a gas for cooling the LEDs. The first substrate and second substrate may be surrounded by a phosphor layer.

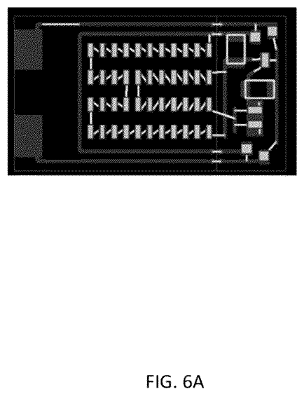

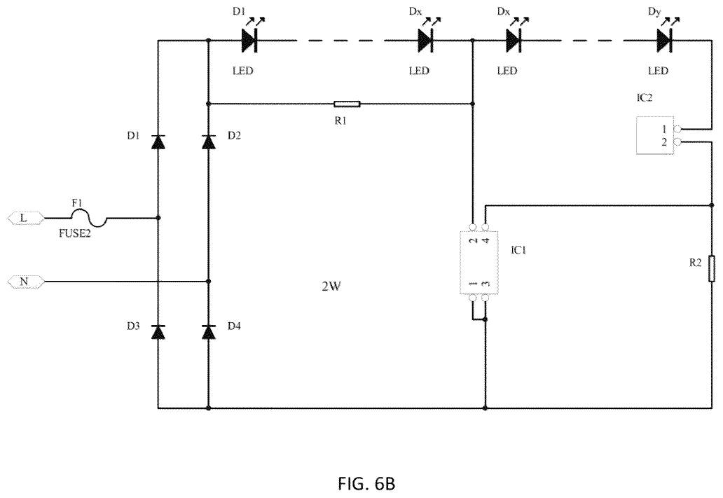

FIGS. 6A and 6B illustrate an exemplary PCB layout for an exemplary light emitting device according to embodiments, as well as an exemplary schematic for an exemplary light emitting device according to embodiments. In examples, the device illustrated in FIGS. 6A and 6B may comprise a luminous flux measurement of 175 lumens.

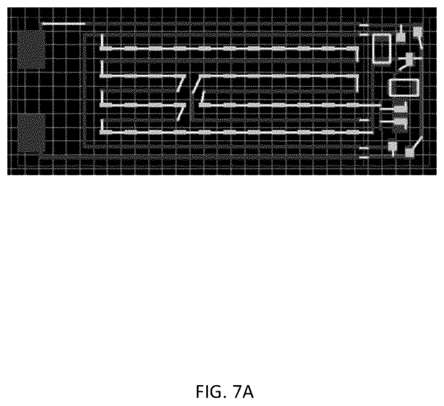

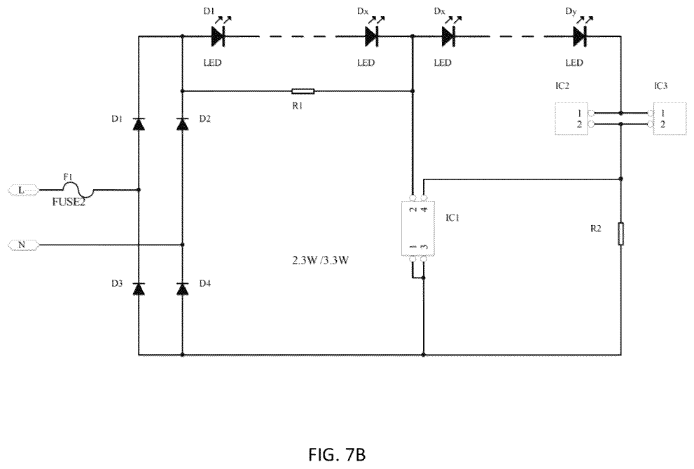

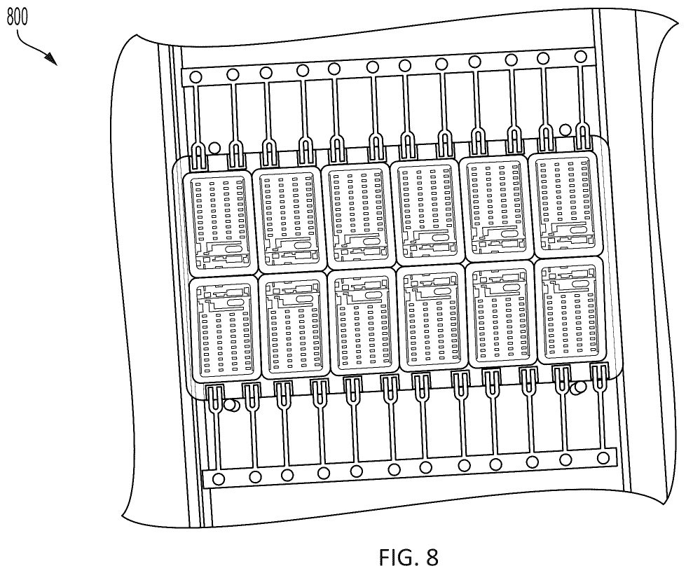

FIGS. 7A and 7B illustrate an exemplary PCB layout for an exemplary light emitting device according to embodiments, as well as an exemplary schematic for an exemplary light emitting device according to embodiments. In examples, the device illustrated in FIGS. 7A and 7B may comprise a luminous flux measurement of one of 225 lumens or 350 lumens.

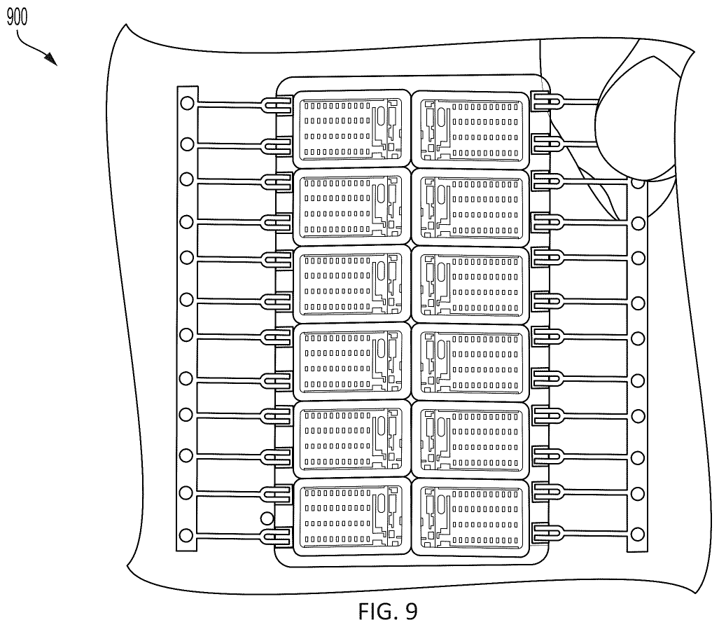

FIGS. 8 and 9 illustrate exemplary light emitting devices 800, 900 for use with embodiments of the present disclosure.

The foregoing Detailed Description signifies in isolation the individual features, structures, functions, or characteristics described herein and any combination of two or more such features, structures, functions or characteristics, to the extent that such features, structures, functions or characteristics or combinations thereof are based on the present specification as a whole in light of the knowledge of a person skilled in the art, irrespective of whether such features, structures, functions or characteristics, or combinations thereof, solve any problems disclosed herein, and without limitation to the scope of the claims. When an embodiment of a claimed invention comprises a particular feature, structure, function or characteristic, it is within the knowledge of a person skilled in the art to use such feature, structure, function, or characteristic in connection with other embodiments whether or not explicitly described, for example, as a substitute for another feature, structure, function or characteristic.

In view of the foregoing Detailed Description it will be evident to a person skilled in the art that many variations may be made within the scope of innovations, embodiments and/or examples, such as function and arrangement of elements, described herein without departing from the principles described herein. One or more elements of an embodiment may be substituted for one or more elements in another embodiment, as will be apparent to those skilled in the art. The embodiments described herein are chosen to signify the principles of the invention and its useful application, thereby enabling others skilled in the art to understand how various embodiments and variations are suited to the particular uses signified.

The foregoing Detailed Description of innovations, embodiments, and/or examples of the claimed inventions has been provided for the purposes of illustration and description. It is not intended to be exhaustive nor to limit the claimed inventions to the precise forms described, but is to be accorded the widest scope consistent with the principles and features disclosed herein. Obviously, many variations will be recognized by a person skilled in this art. Without limitation, any and all equivalents described, signified or incorporated by reference in this patent application are specifically incorporated by reference into the description herein of the innovations, embodiments and/or examples. In addition, any and all variations described, signified or incorporated by reference herein with respect to any one embodiment are also to be considered taught with respect to all other embodiments. Any such variations include both currently known variations as well as future variations, for example any element used herein includes a future equivalent element that provides the same function, regardless of the structure of the future equivalent.

It is intended that the scope of the claimed inventions be defined and judged by the following claims and equivalents. The following claims are hereby incorporated into the Detailed Description, with each claim standing on its own as a separate embodiment. Disclosed embodiments can be described with more features than are expressly recited in the claims.

1. A substrate assembly comprising:
a first substrate having an outer surface;
a second substrate adjacent the first substrate and having driver circuitry positioned thereon, and
a wire connection electrically coupling the first substrate and the second substrate,
wherein:
one or more arrays of light emitting diodes are confined to the first substrate, such that the second substrate is free of light emitting diodes; and
the driver circuitry drives the one or more arrays of light emitting diodes via the wire connection.

2. The substrate assembly of claim 1, further comprising a third substrate positioned intermediate the first and second substrate.

3. The substrate assembly of claim 1, further comprising a phosphor layer positioned atop the outer surface of one or more of the first substrate and the second substrate.

4. The substrate assembly of claim 1, wherein the assembly is mounted to a ceramic base.

5. The substrate assembly of claim 4, wherein the base is one or more of an Edison base, an E11 base, a G4 base, a G8 base, a G9 base, a Wedge base, a Bayonet base, or a DC Bayonet base.

6. The substrate assembly of claim 1, wherein the one or more arrays of light emitting diodes are configured for emitting light in one or more of a wall fixture, a step light, a mini pendant light, a decorative sconce light, a desk lamp, or an outdoor fixture.

7. The substrate assembly of claim 1, wherein the assembly is positioned within an enclosure that is one or more of transparent, clear, opaque, shatterproof, glass, or plastic.

8. The substrate assembly of claim 7, wherein the enclosure is filled with gas for cooling the LED arrays.

9. The substrate assembly of claim 1, wherein the third substrate is a sapphire or ceramic material.

10. A method of manufacturing a substrate assembly, the method comprising:
attaching one or more arrays of light emitting diodes to a surface of a first substrate of the substrate assembly;
attaching driver circuitry to a surface of a second substrate of the substrate assembly, the second substrate being free of any light emitting diode arrays; and
electrically coupling the first substrate and the second substrate with a wire connection such that the driver circuitry drives the one or more arrays of light emitting diodes via the wire connection.

11. The method of claim 10, further comprising the step of applying a phosphor layer on the surface of one or more of the first substrate or the second substrate.

12. The method of claim 10, further comprising the step of attaching a ceramic base to the substrate assembly.

13. The method of claim 10, further comprising attaching one or more of an Edison base, an E11 base, a G4 base, a G8 base, a G9 base, a Wedge base, a Bayonet base, or a DC Bayonet base to the substrate assembly.

14. The method of claim 10, further comprising the step of attaching an enclosure to the substrate assembly.

15. The method of claim 14, wherein the enclosure is one or more of transparent, clear, opaque, shatterproof, glass, or plastic.

16. The method of claim 15, further comprising filling the enclosure with gas for cooling the LED arrays.

17. A method of manufacturing a substrate assembly, the method comprising:
attaching one or more arrays of light emitting diodes to a first outward facing surface of a first substrate of the substrate assembly;
attaching driver circuitry to a second outward facing surface of a second substrate of the substrate assembly, wherein the second substrate has at least one of size or a shape identical to that of the first substrate, and wherein the second substrate is free of light emitting diodes;
positioning a third substrate intermediate the first and second substrates; and
electrically coupling the first substrate and the second substrate with a wire connection such that the driver circuitry drives the one or more arrays of light emitting diodes via the wire connection.

18. The method of claim 17, wherein the third substrate comprises sapphire or ceramic material.

19. The method of claim 17, further comprising the step of attaching an enclosure to the substrate assembly and filling the enclosure with gas for cooling the LED arrays.

20. The method of claim 19, wherein the enclosure is one or more of transparent, clear, opaque, shatterproof, glass, or plastic.
